(19) United States
(12) Patent Application Publication
(10) Pub. No.: US 2025/0116310 A1
(43) Pub. Date: Apr. 10, 2025

(54) SHOCK-ABSORPTION STRUCTURE

(71) Applicant: TILTA INC., Burbank, CA (US)

(72) Inventors: Yiling WANG, Shenzhen (CN); Wenping ZENG, Shenzhen (CN); Kefeng ZHOU, Shenzhen (CN)

(21) Appl. No.: 18/893,487

(22) Filed: Sep. 23, 2024

(30) Foreign Application Priority Data
Oct. 10, 2023 (CN) 2023227365297

(51) Int. Cl. F16F 7/104

(52) U.S. Cl. CPC F16F 7/104; F16F 2222/08

(57) ABSTRACT

The present disclosure relates to shock-absorption technology, particularly a shock-absorption structure that includes a first shock-absorption body, a second shock-absorption body, and at least one set of elastic shock-absorbing components. The first shock-absorption body surrounds the exterior of the second shock-absorption body, forming a movable gap between the first shock-absorption body and the second shock-absorption body. Both shock-absorption bodies are connected with the elastic shock-absorbing components. The shock-absorption first body is equipped with a first mounting point for affixing an external device, while the second shock-absorption body features a second mounting point for the same purpose. An external camera and an external shock-absorbing arm structure can be installed at the respective mounting points of the first and second shock-absorption bodies. During filming, when the camera experiences jitter or inertial movements, the shock-absorption structure effectively dampens these motions, enhancing the camera's operational stability.

### CROSS-REFERENCE TO RELATED APPLICATIONS

The present application for patent claims priority to and the benefit of pending Chinese Application No. 2023227365297, filed Oct. 10, 2023, and hereby expressly incorporated by reference herein as if fully set forth below in its entirety and for all applicable purposes.

### TECHNICAL FIELD

The present disclosure pertains to the realm of shock-absorption technology, specifically concerning a shock-absorption structure.

### INTRODUCTION

When capturing footage with a moving camera, both indoors and outdoors, ensuring image stability is crucial. To achieve this, cameras are often mounted on shock-absorbing arm structures designed to mitigate vibrations. In conventional designs, these structures can include a shock-absorbing arm, shock-absorbing springs, and a shock-absorbing arm body. The arm can be mounted on the body via springs, and a camera connection component attached to the body's head facilitates camera attachment. In these structures, while the springs contribute to shock-absorption by buffering, during filming, the camera's sensitivity to shaking and lateral inertia can lead to disengagement from the arm body's head, compromising stability.

### BRIEF SUMMARY

To address the challenges encountered in traditional designs, aspects of this disclosure introduce a shock-absorption structure capable of effectively dampening camera shaking and inertial movements, thereby enhancing camera stability during use.

To accomplish this goal, the technical solution embodied in the disclosure revolves around the followings.

A shock-absorption structure, comprising a first shock-absorption body, a second shock-absorption body, and an elastic shock-absorbing component;
a movable gap is configured between the first shock-absorption body and the second shock-absorption body; both the first shock-absorption body and the second shock-absorption body are connected with the elastic shock-absorbing component; the first shock-absorption body is provided with a first mounting position, and the second body is provided with a second mounting position.
wherein the first shock-absorption body and the second shock-absorption body are configured to be circular.
wherein the shock-absorption structure is provided with at least one shock-absorption zone; a plurality of first holes extend through the shock-absorption zone of the first shock-absorption body, and a plurality of second holes extend through the shock-absorption zone of the second shock-absorption body; the elastic shock-absorbing component is inserted through the first holes and the second holes.
wherein the elastic shock-absorbing component comprises a first elastic shock-absorbing part and a second elastic shock-absorbing part; the first elastic shock-absorbing part is positioned along one side of the movable gap, the second elastic shock-absorbing part is positioned on an opposite side of the movable gap from the first elastic shock-absorbing part; and, two ends of the first elastic shock-absorbing part and two ends of the second elastic shock-absorbing part are positioned within corresponding the first hole and the second hole.
wherein the elastic shock-absorbing component comprises a plurality of elastic shock-absorbing components, comprising a plurality of first elastic shock-absorbing parts and a plurality of second elastic shock-absorbing parts; the first shock-absorption body and the second shock-absorption body are provided with a plurality of shock-absorption zone; each shock-absorption zone of the first shock-absorption body comprises a plurality of first holes; each shock-absorption zone of the second shock-absorption body comprises a plurality of first holes; the plurality of first elastic shock-absorbing parts positioned along one side of the movable gap, the second elastic shock-absorbing parts are positioned on an opposite side of the movable gap from the first elastic shock-absorbing part; two ends of the first elastic shock-absorbing parts and two ends of the first elastic shock-absorbing parts are positioned within corresponding the first holes and the second holes, and two ends of the first elastic shock-absorbing parts connected to two ends of the second elastic shock-absorbing parts.
wherein an outer side or inner side of the first shock-absorption body is provide with a plurality of first locking holes for communicating with the first holes; a plurality of locking member are correspondingly positioned in the plurality of first locking holes to secure the elastic shock-absorbing component located within the first holes; an outer side or inner side of the second shock-absorption body is provide with a plurality of second locking holes for communicating with the second holes; a plurality of locking member are correspondingly positioned in the plurality of second locking holes to secure the elastic shock-absorbing component located within the second holes.
wherein the first hole's number is equal to the second hole's number.
wherein the number of first hole is configured to be multiple times greater than the number of the second hole; each the second hole corresponds to a plurality of first holes.
wherein the elastic shock-absorbing component comprises a plurality of, and a first end of each elastic shock-absorbing component a first hole, while second ends of several elastic shock-absorbing components collectively pass through a second hole.
wherein the elastic shock-absorbing component comprises an elastic member configured to sequentially traverse a plurality of first holes and subsequently a plurality of second holes.
wherein the shock-absorption structure is provided with a plurality of shock-absorption zones,; a plurality of elastic shock-absorbing components are respectively arranged at the plurality of shock-absorption zones, and are symmetrically configured.
wherein the first mounting position comprises a first mounting hole piercing through the first shock-absorption body, while the second mounting position comprises a second mounting hole piercing through the second shock-absorption body.
wherein the shock-absorption structure includes a third shock-absorption body; a movable gap is configured between the first shock-absorption body and the third shock-absorption body; and the first shock-absorption body and the third shock-absorption body are connected via at least one elastic shock-absorbing component.

The beneficial effects of the present disclosure stem from the design that the shock-absorption structure allows for the installation of an external camera and an external shock-absorbing arm structure at the respective mounting points of the first and second shock-absorption bodies. During filming, when the camera experiences jitter or inertial movements, the arrangement of elastic shock-absorbing components interposed between a first shock-absorption body and a second shock-absorption body imparts a degree of freedom of movement to the first shock-absorption body relative to the second shock-absorption. Therefore, the structure effectively dampens these motions, enhancing the camera's operational stability.

### BRIEF DESCRIPTION OF THE DRAWINGS

FIG. 1 is a schematic diagram of a shock-absorption structure according to a first embodiment.

FIG. 2 is a schematic diagram of the shock-absorption structure of FIG. 1 with an elastic shock-absorbing components hidden.

FIG. 3 is an axonometric view of the shock-absorption structure of FIG. 1.

FIG. 4 is a schematic diagram of a shock-absorption structure with an elastic shock-absorbing components hidden according to a second embodiment.

FIG. 5 is a structural diagram of the shock-absorption structure of FIG. 4.

FIG. 6 is a schematic diagram of a shock-absorption structure with an elastic shock-absorbing components hidden according to a third embodiment.

FIG. 7 is a schematic diagram of the shock-absorption structure of FIG. 6.

FIG. 8 is a schematic diagram of a shock-absorption structure with an elastic shock-absorbing components hidden according to a fourth embodiment.

FIG. 9 is an axonometric view of the shock-absorption structure of FIG. 8.

FIG. 10 is a schematic diagram of a shock-absorption structure with an elastic shock-absorbing components hidden according to a fifth embodiment.

FIG. 11 is a schematic diagram of the shock-absorption structure of FIG. 10.

FIG. 12 is an axonometric view of the shock-absorption structure of a sixth embodiment.

### LABEL EXPLANATIONS

1—First shock-absorption body; 11—First hole; 12—First locking hole; 13—First mounting position; 131—First mounting hole;
2—Second shock-absorption body; 21—Second hole; 22—Second locking hole; 23—Second mounting point; 231—Second mounting hole;
3—Elastic shock-absorbing component; 31—First elastic shock-absorbing part; 32—Second elastic shock-absorbing part; 33—First elastic member; 34—First elastic ring; 35—Second elastic member; 36—Second elastic ring;
4—Movable gap
5—Shock-absorption zone.
61/62/63/64—locking member;
7—Third shock-absorption body;
8—Movable gap.

### DETAILED DESCRIPTION

To clarify the objectives, technical solutions, and advantages of the present disclosure, the following detailed explanations are provided in conjunction with the accompanying drawings and embodiments. It is important to note that the specific embodiments presented herein serve solely as illustrative examples and are not intended to restrict the scope of the present disclosure.

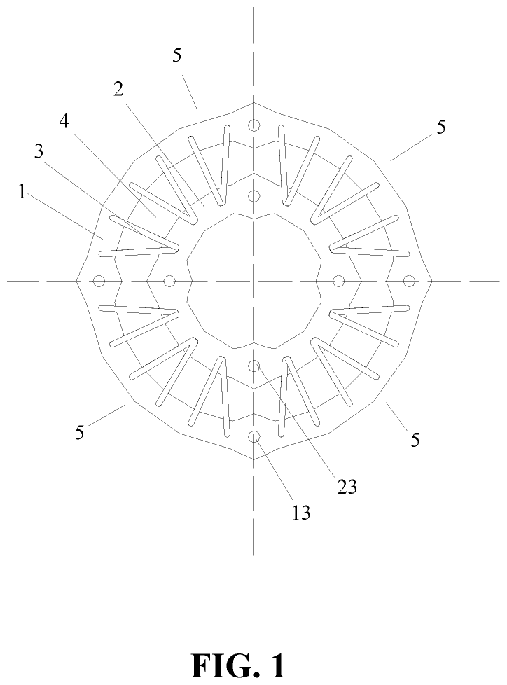

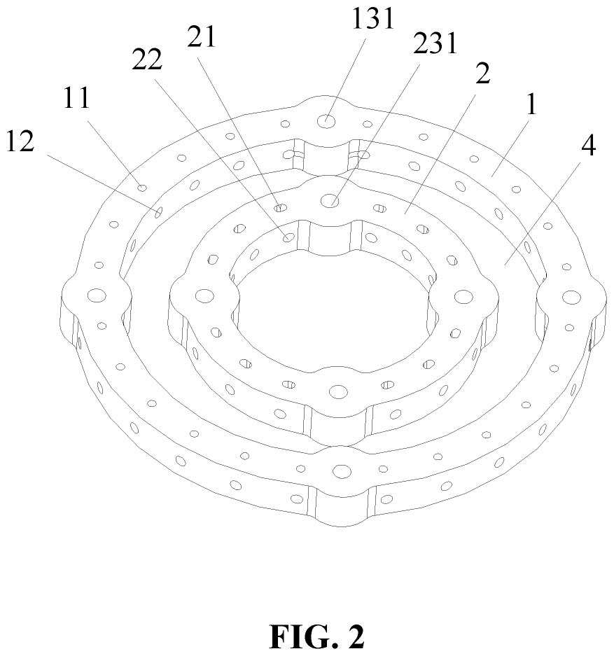

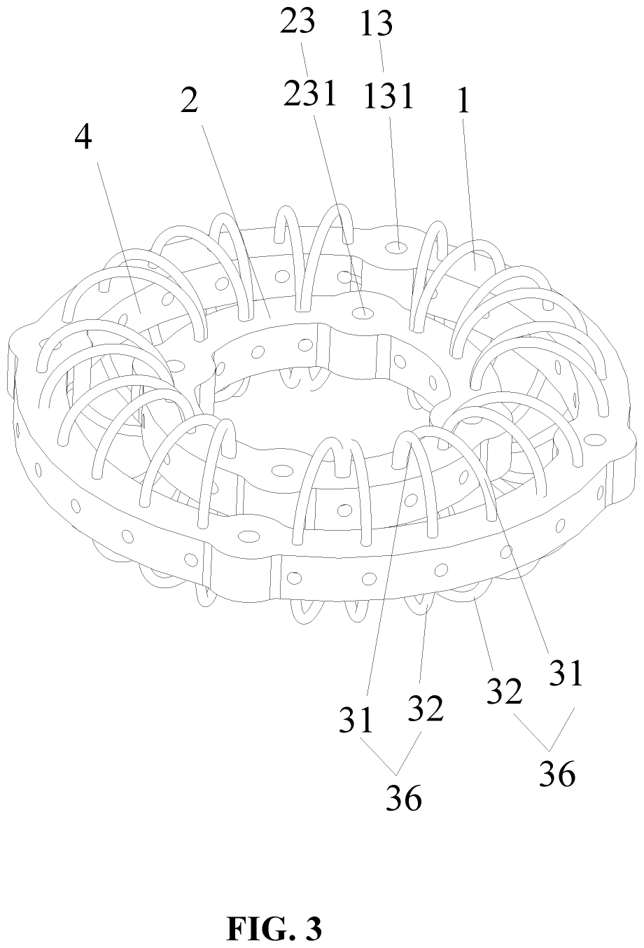

Referring to FIGS. 1-3, a first embodiment of the present disclosure is introduced. This embodiment discloses a shock-absorption structure that encompasses a first shock-absorption body 1, a second shock-absorption body 2, and at least one elastic shock-absorbing component 3. The first shock-absorption body 1 envelopes the exterior of the second shock-absorption body 2, creating a movable gap 4 (e.g., an adjustable gap) between the first shock-absorption body 1 and the second shock-absorption body 2. Both the first shock-absorption body 1 and the second shock-absorption body 2 are connected with the elastic shock-absorbing component 3. The first shock-absorption body 1 is equipped with a first mounting position 13 for affixing an external device. For example, the first mounting position 13 can accommodate the installation of either an external camera or an external shock-absorbing arm. The second shock-absorption body 2 features a second mounting position 23 for the same purpose as the first mounting position 13, and the second mounting position 23 also can support the attachment of either an external camera or an external shock-absorbing arm. Notably, the existence of the movable gap 4 between the first shock-absorption body 1 and the second shock-absorption body 2 enables a degree of relative motion between them. This relative motion is effectively buffered or dampened by the elastic shock-absorbing component 3.

Within this embodiment, the elastic shock-absorbing component 3 includes a first elastic shock-absorbing part 31 and a second elastic shock-absorbing part 32. A plurality of first elastic shock-absorbing parts 31 are positioned on one side of the movable gap 4, with their respective ends connected to one side of the first shock-absorption body 1 and the second shock-absorption body 2. The side of the first shock-absorption body 1 is facing upwards relative to its own inner and outer surfaces and the side of the second shock-absorption body 2 is facing upwards relative to its own inner and outer surfaces. Conversely, A plurality of the elastic second shock-absorbing parts 32 are disposed on the opposite side of the movable gap 4, away from the first elastic shock-absorbing part 31, and their ends are attached to the corresponding sides of the shock-absorbing bodies 1 and 2 that are opposite to the first set of elastic shock-absorbing part 31. The opposite side of the first shock-absorption body 1 is oriented downwards in relation to its inner and outer surfaces, while the corresponding side of the second shock-absorption body 2 is also positioned downwards relative to its own inner and outer surfaces. The synergy between the multiple first elastic shock-absorbing parts 31 and the multiple second shock-absorbing parts 32 reinforces the cushioning capability of the elastic shock-absorbing components 3 during relative motion between the first shock-absorption body 1 and the second shock-absorption body 2.

In this embodiment, at least one shock-absorption zone 5 is included in the shock-absorption structure. Within the shock-absorption zone 5, A plurality of first holes 11 are positioned to penetrate the first shock-absorption body 1, while multiple second holes 21 are positioned to penetrate the second shock-absorption body 2. The ends of the first elastic shock-absorbing parts 31 are positioned at one end of the respective first holes 11 and at one end of the second holes 21. Similarly, the ends of the second shock-absorbing parts 32 are situated at the opposite ends of the first holes 11 and the second holes 21, away from the first elastic shock-absorbing parts 31. In essence, the first elastic shock-absorbing parts 31 and second elastic shock-absorbing parts 32 are interconnected with the first shock-absorption body 1 and second shock-absorption body 2 through the respective first holes 11 and second holes 21, thereby significantly enhancing connection stability.

In this embodiment, each of the first holes 11 incorporates a first locking hole 12 that traverses the interior side or exterior the first shock-absorption body 1. Specifically, the first locking hole 12 extends from the exterior of the first shock-absorption body 1 into the corresponding the first hole 11 and further into the interior of the first hole. Additionally, a locking member (e.g., locking members 61, 62, 63, 64) is movably installed within the first locking hole 12 to secure the first elastic shock-absorbing part 31 and the second elastic shock-absorbing parts 32 positioned within the first hole 11.

The second hole 21 incorporates a second locking hole 22 that traverses the interior or exterior side of the second shock-absorption body 2. Specifically, the second locking hole 22 extends from the exterior of the second shock-absorption body 2 into the corresponding second hole 21 and further into its interior. Additionally, a locking member (e.g., locking members 61, 62, 63, 64) is movably installed within the second locking hole 22 to secure the first elastic shock-absorbing parts 31 and the second elastic shock-absorbing parts 32 positioned within the second hole 21. In some aspects, the locking member can include a screw-type mechanism.

In this embodiment, the shock-absorption structure includes four shock-absorption zones 5, each accommodating a set of elastic shock-absorbing components 3, totaling four sets. These sets are arranged within the four shock-absorption zones 5 and exhibit a symmetrical configuration. For example, any two opposing sets of elastic shock-absorbing components 3 can be mirror images of each other.

In this embodiment, the first mounting position 13 can be a first mounting hole 131 that spans the entire width of the first shock-absorption body 1. Similarly, the second mounting point 23 can be a second mounting hole 231 traversing the second shock-absorption body 2. These mounting holes 131 and 231 enable the attachment of external cameras or shock-absorption arms to either side of the respective the first shock-absorption body 1 and the second shock-absorption body 2, thereby enhancing the versatility of the shock-absorption structure. Specifically, the two sides of the first shock-absorption body 1, as well as those of the second shock-absorption body 2, are oriented in relation to their interiors and exteriors, with one side facing downwards and the other upwards.

In this embodiment, both the first mounting holes 131 and the second mounting holes 231 be equal in numbers, for example four each. The four first mounting holes 131 can be evenly distributed across the first shock-absorption body 1, while the four second mounting holes 231 can be similarly arranged on the second shock-absorption body, with corresponding positions aligning between these four first mounting holes 131 and second mounting holes 231.

In this embodiment, the first shock-absorption body 1 and the second shock-absorption body 2 can be constructed as integral annular structures.

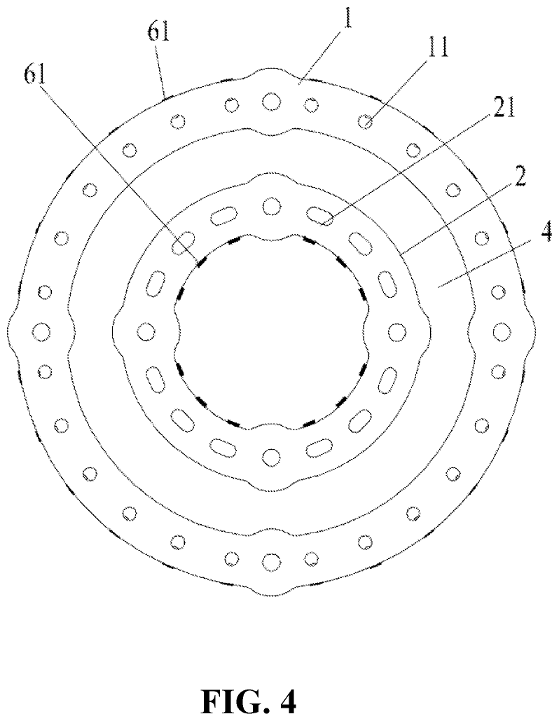

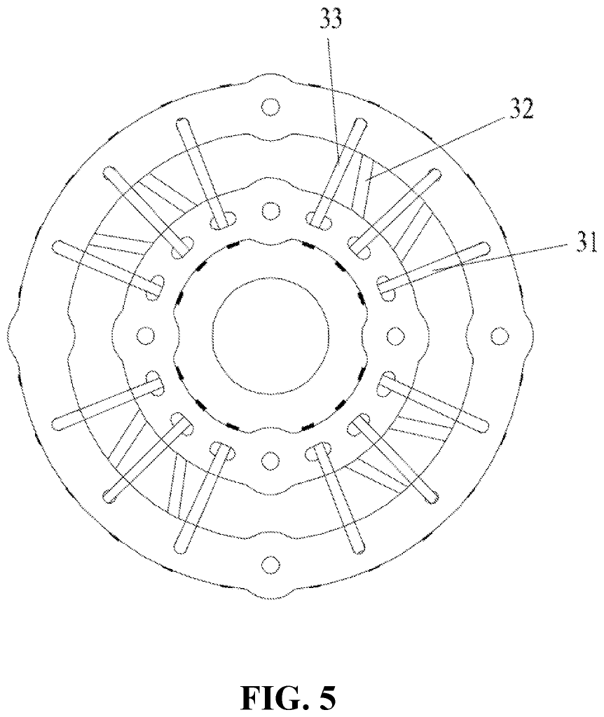

Moving on to a shock-absorption structure according to the second embodiment, as depicted in FIGS. 4-5, Similar to the first embodiment, the shock-absorption structure of the second embodiment has equal numbers of first holes 11 and second holes 21.

The elastic shock-absorbing component 3 includes an first elastic member 33, which sequentially traverses through a series of first holes 11 and second holes 21, forming multiple segments of the first elastic shock-absorbing parts 31 and the second elastic shock-absorbing parts 32.

In some aspects, within the shock-absorption zone 5, the first elastic member 33 sequentially traverses through multiple alternating first holes 11 and second holes 21 in a winding pattern (e.g., Nov. 21, 2011-21 . . . ). Upon completion of this installation, the portion of the first elastic member 33 situated on one side of the moving gap 4 constitutes the multiple segments of the first elastic shock-absorbing parts 31, whereas the segment located on the opposite side, away from the first elastic shock-absorbing parts 31, includes the multiple segments of the second elastic shock-absorbing parts 32.

The first elastic member 33 is retained in position by a locking piece (e.g., one or more locking members 61), which is movably situated within both the first locking hole 12 and the second locking hole 22.

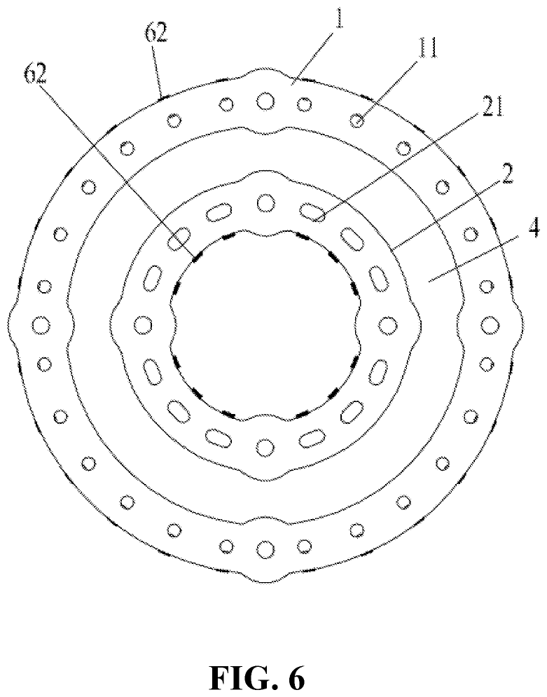

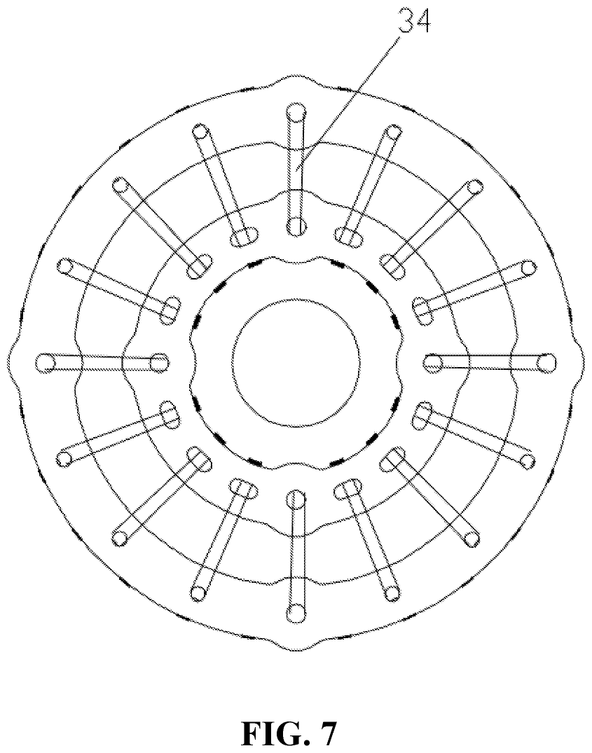

FIGS. 6 and 7 illustrate a shock-absorption structure according to the third embodiment. Similar to the first embodiment, the third embodiment has equal numbers of first holes 11 and second holes 21.

The elastic shock-absorbing component 3 includes a series of first elastic rings 34 (FIG. 7), where each ring's ends traverse through corresponding first locking holes 11 and second locking holes 21, respectively, forming the first elastic shock-absorbing parts 31 and the second elastic shock-absorbing parts 32.

In some aspects, within the shock-absorption zone 5, the elastic shock-absorbing component 3 incorporates numerous first elastic rings 34, each assigned to a pair of first locking hole 11 and second hole 21. The ends of each first elastic ring 34 penetrate their respective first locking hole 11 and second hole 21. The segments of the first elastic rings 34 residing on one side of the movable gap 4 include the multiple first elastic shock-absorbing parts 31, whereas the segments on the opposite side of the gap, facing away from the first elastic shock-absorbing parts 31, constitute the multiple second elastic shock-absorbing parts 32.

The first elastic rings 34 can be anchored or fixed in place by a locking piece (e.g., one or more locking members 62). Each locking piece is movably positioned within the first locking hole 12 or second locking hole 22.

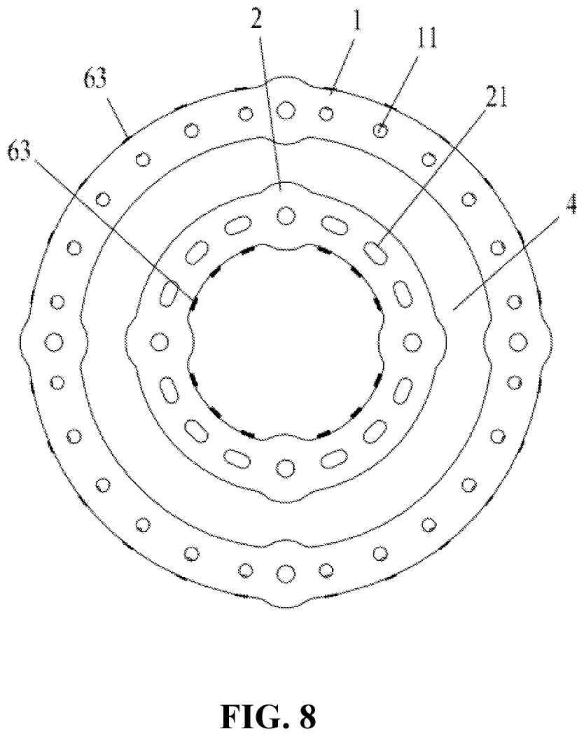

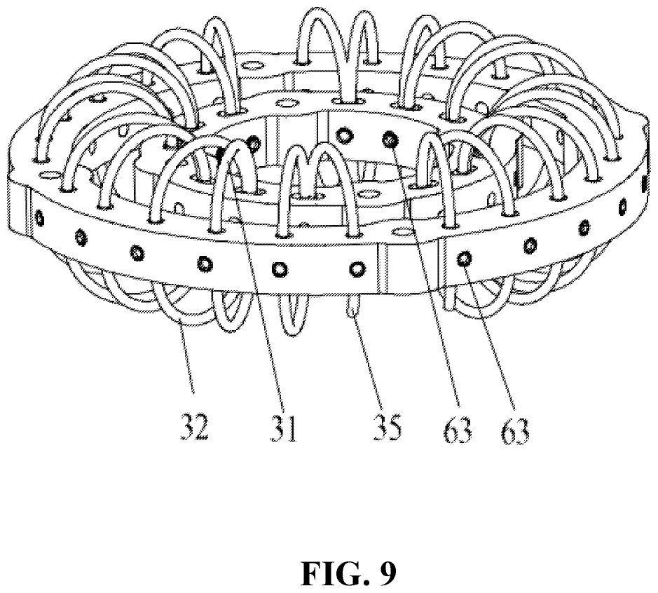

FIGS. 8 and 9 illustrate a shock-absorption structure according to a fourth embodiment. Different from the first embodiment, the fourth embodiment features twice the number of first holes 11 compared to the second holes 21, with each second hole 21 paired with two first holes 11.

The elastic shock-absorbing component 3 in this embodiment includes an second elastic member 35, which is sequentially threaded through first holes 11 and multiple second holes 21, resulting in the formation of multiple first elastic shock-absorbing parts 31 and multiple second elastic shock-absorbing parts 32.

Specifically, within the shock-absorption zone 5, the second elastic member 35 sequentially traverses through multiple alternating first holes 11 and second holes 21 in a winding pattern (e.g., 11-21-11-21 . . . ). In contrast to second embodiment, the fourth embodiment demonstrates a unique configuration where the second elastic member 35 proceeds from a first shock-relieve vent (e.g., a first hole 11) to a second hole 21, subsequently through another first shock-relieve vent (e.g., another first hole 11) before re-entering the same second hole 21, and finally extending into a third first shock-relieve vent (e.g., yet another first hole 11), thereby establishing a correspondence between one second hole 21 and two first holes 11. Upon installation of this singular second elastic member 35, the segments positioned on one side of the movable gap 4 collectively form multiple first elastic shock-absorbing parts 31, while the segments situated on the opposite side of the gap, facing away from the first elastic shock-absorbing parts 31, constitute multiple second shock-absorbing parts 32. Notably, the first elastic shock-absorbing parts 31 traversing the same second hole 21 are arranged in a symmetrical “splay” pattern, mirroring the arrangement of the second elastic shock-absorbing parts 32 that also pass through the same second hole 21.

The second elastic member 35 is retained in position by a locking piece (e.g., one or more locking members 63). The locking piece can be movably situated within the first locking hole 12 or the second locking hole 22.

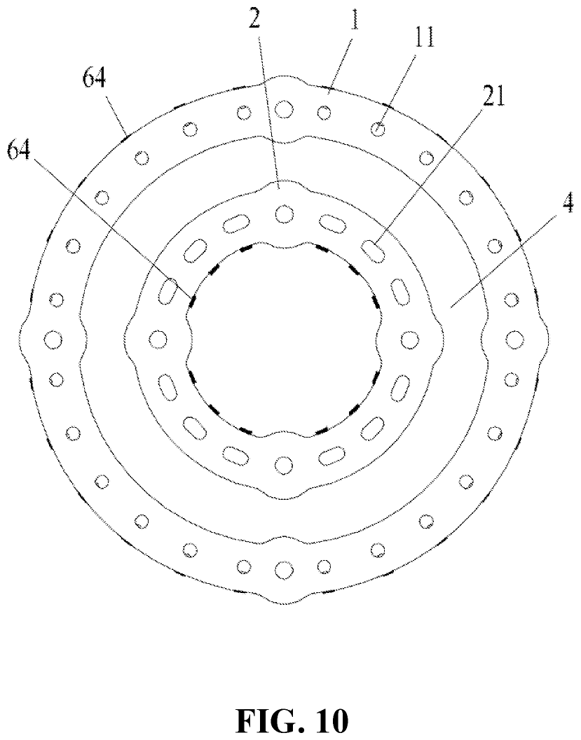

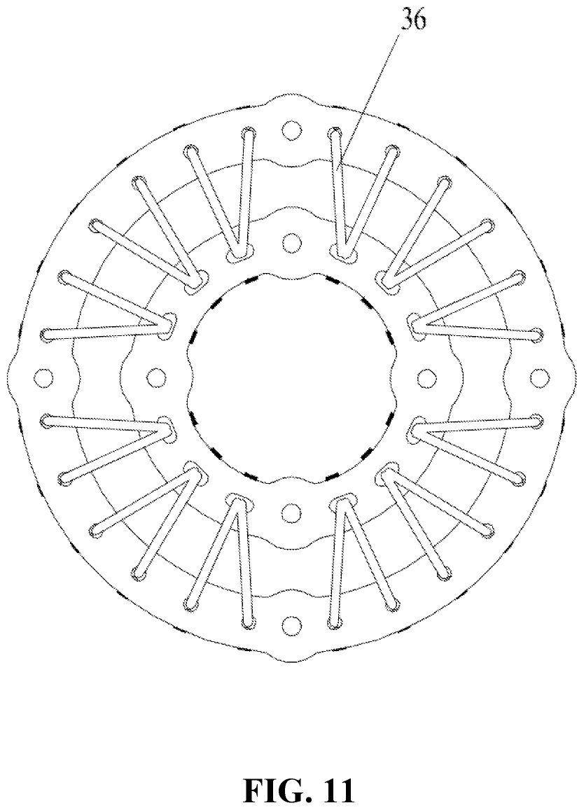

FIGS. 10 and 11 illustrate a shock-absorption structure according to a fifth embodiment. Different from the first embodiment, the shock-absorption structure of the fifth embodiment features twice the number of first holes 11 as compared to second holes 21, with each second hole 21 paired with two first holes 11.

The elastic shock-absorbing component 3 includes multiple second elastic rings 36, where the ends of two adjacent second elastic rings 36 individually traverse through two neighboring first holes 11, and the opposite ends of these two second elastic rings 36, within these adjacent first holes 11, jointly penetrate a single second hole 21 that corresponds to those first holes 11, resulting in the formation of two segments of first elastic shock-absorbing parts 31 and two segments of second elastic shock-absorbing parts 32.

Specifically, within the shock-absorption zone 5, the elastic shock-absorbing component 3 includes multiple second elastic rings 36, each uniquely associated with one first shock-relieve vent (e.g., a first hole 11) and one second hole 21. The two ends of each second elastic ring 36 pass through their respective first hole 11 and second hole 21. However, in the fifth embodiment, differing from third embodiment, one end of two second elastic rings 36 first traverses a single second hole 21, and the other ends of these two second elastic rings 36 then pass through two different first holes 11 that correspond to this second hole 21, creating a symmetrical “splay” configuration. The segments of second elastic rings 36 positioned on one side of the moving gap 4 constitute multiple segments of first elastic shock-absorbing parts 31, while those located on the opposite side of the moving gap 4, facing away from the first elastic shock-absorbing parts 31, form multiple segments of second shock-absorbing parts 32.

The second elastic rings 36 can be anchored or fixed in place by a locking piece (e.g., one or more locking member 64). The locking piece is movably positioned within the first locking hole 12 or second locking hole 22.

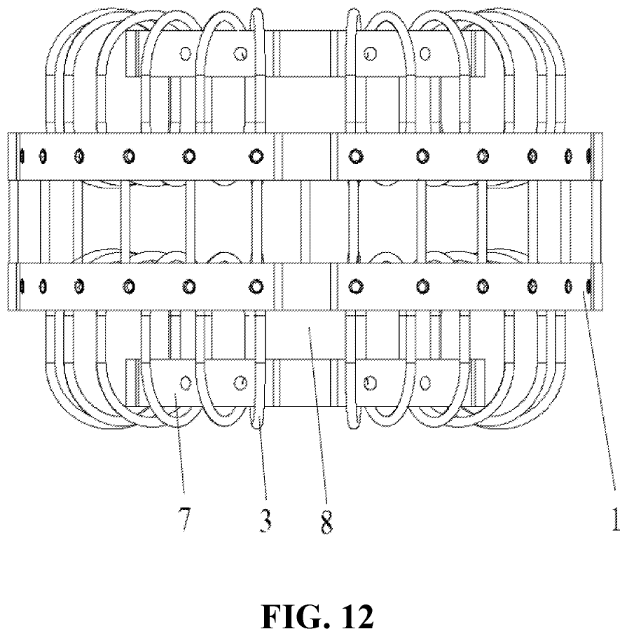

FIG. 12 illustrates a shock-absorption structure according to a sixth embodiment, which can build upon any of the preceding first thought fifth embodiments. This shock-absorption structure introduces a third shock-absorption body 7, with the elastic shock-absorbing components 3 present in at least two groups. The third shock-absorption body 7 is arranged circumferentially around the exterior of the first shock-absorption body 1, creating a moving gap 8 between the first shock-absorption body 1 and the third shock-absorption body 7. The first shock-absorption bodies 1 and the third shock-absorption bodies 3 are interconnected via multiple groups of elastic shock-absorbing components 3.

Specifically, in the context of this disclosure, the term “exterior” refers to the zone situated beyond the interior confines of the respective structure.

It is important to note that the above descriptions represent only exemplary embodiments of the present disclosure and are not intended to restrict its scope. Any variations, equivalent substitutions, or improvements that adhere to the spirit and fundamental principles of the invention shall be deemed as falling within the scope of protection granted by the present disclosure.

What is claimed is:

1. A shock-absorption structure, comprising:
a first shock-absorption body provided with a first mounting position;
a second shock-absorption body provided with a second mounting position; and
an elastic shock-absorbing component connected to both the first shock-absorption body and the second shock-absorption body, wherein a movable gap is configured between the first shock-absorption body and the second shock-absorption body.

2. The shock-absorption structure according to claim 1, wherein the first shock-absorption body and the second shock-absorption body are each configured to be in a circular shape.

3. The shock-absorption structure according to claim 1, wherein the shock-absorption structure is provided with at least one shock-absorption zone;
a plurality of first holes extend through the shock-absorption zone of the first shock-absorption body, and a plurality of second holes extend through the shock-absorption zone of the second shock-absorption body; and
the elastic shock-absorbing component passes through the first holes and the second holes.

4. The shock-absorption structure according to claim 3, wherein the elastic shock-absorbing component comprises a first elastic shock-absorbing part and a second elastic shock-absorbing part;
the first elastic shock-absorbing part is positioned along a first side of the movable gap, the second elastic shock-absorbing part is positioned on a second side, opposite to the first side of the movable gap from the first elastic shock-absorbing part; and
a first end of the first elastic shock-absorbing part and a first end of the second elastic shock-absorbing part are positioned within the corresponding first hole of the plurality of first holes, and a second end of the first elastic shock-absorbing part and a second end of the second elastic shock-absorbing part are positioned within the corresponding second hole of the plurality of second holes.

5. The shock-absorption structure according to claim 4, wherein the elastic shock-absorbing component comprises a plurality of first elastic shock-absorbing parts and a plurality of second elastic shock-absorbing parts;
the first shock-absorption body and the second shock-absorption body are provided with a plurality of shock-absorption zone, each shock-absorption zone of the first shock-absorption body comprises a plurality of first holes, and each shock-absorption zone of the second shock-absorption body comprises a plurality of second holes;
the plurality of first elastic shock-absorbing parts are positioned on a first side of the movable gap, the plurality of second elastic shock-absorbing parts are positioned on a second side, opposite to the first side of the movable gap from the plurality of first elastic shock-absorbing parts; and
two ends of the first elastic shock-absorbing parts and two ends of the second elastic shock-absorbing parts are positioned within the corresponding first holes of the plurality of first holes and the corresponding second holes of the plurality of second holes, and two ends of the first elastic shock-absorbing parts connected to two ends of the second elastic shock-absorbing parts.

6. The shock-absorption structure according to claim 3, wherein an outer side or inner side of the first shock-absorption body is provided with a plurality of first locking holes for communicating with the plurality of first holes;
a plurality of locking members are respectively positioned in the plurality of first locking holes to secure the elastic shock-absorbing component located at least partially within the first plurality of holes;
an outer side or inner side of the second shock-absorption body is provided with a plurality of second locking holes for communicating with the second holes; and
a plurality of locking members are respectively positioned in the plurality of second locking holes to secure the elastic shock-absorbing component located at least partially within the plurality of second holes.

7. The shock-absorption structure according to claim 3, wherein the plurality of first holes and the plurality of second holes are equal in quantity.

8. The shock-absorption structure according to claim 7, wherein the elastic shock-absorbing component comprises a plurality of first elastic members, and a plurality of shock-absorption zone are provided corresponding to the plurality of first elastic members; each first elastic member of the plurality of first elastic members sequentially passes through the plurality of first holes and the plurality of second holes corresponding to a respective shock-absorption zone of the plurality of shock-absorption zones.

9. The shock-absorption structure according to claim 7, wherein the elastic shock-absorbing component comprises a plurality of first elastic rings, the plurality of first elastic rings, the plurality of first holes, and the plurality of second holes are equal in quantity; and
each first elastic ring of the plurality of first elastic rings passes through the corresponding first hole of the plurality of first holes and the corresponding second hole of the plurality of second holes.

10. The shock-absorption structure according to claim 3, wherein the plurality of first holes are greater in quantity than the plurality of second holes; and
each the plurality of second holes corresponds to multiple first holes of the plurality of first holes.

11. The shock-absorption structure according to claim 9, wherein a quantity of the plurality of first holes is double that of the plurality of second holes; the elastic shock-absorbing component comprises a plurality of second elastic members, and a plurality of shock-absorption zone are provided corresponding to the plurality of second elastic members;
each second elastic member of the plurality of second elastic members sequentially passes through the plurality of first holes and the plurality of second holes corresponding to a respective shock-absorption zone of the plurality of shock-absorption zone; and
the second elastic member passes through each second hole of the plurality of second holes twice.

12. The shock-absorption structure according to claim 9, wherein the elastic shock-absorbing component comprises a plurality of second elastic rings, the plurality of second elastic rings and the plurality of first holes are equal in quantity; and
each second elastic ring of the plurality of second elastic rings passes through one first hole and two corresponding second holes.

13. The shock-absorption structure according to claim 10, wherein the elastic shock-absorbing component comprises a plurality of elastic shock-absorbing components; and
a first end of each elastic shock-absorbing component passes through a first hole of the plurality of first holes, and second ends of several of the plurality of elastic shock-absorbing components collectively pass through a second hole of the plurality of second holes.

14. The shock-absorption structure according to claim 10, wherein the elastic shock-absorbing component comprises an elastic member configured to sequentially traverse the plurality of first holes and subsequently the plurality of second holes.

15. The shock-absorption structure according to claim 3, wherein the shock-absorption structure is provided with a plurality of shock-absorption zones; and
the elastic shock-absorbing component comprises multiple sets of elastic shock-absorbing components, the multiple sets of elastic shock-absorbing components are respectively arranged at the plurality of shock-absorption zones, and are symmetrically configured.

16. The shock-absorption structure according to claim 1, wherein the first mounting position comprises a first mounting hole piercing through the first shock-absorption body, while the second mounting position comprises a second mounting hole piercing through the second shock-absorption body.

17. The shock-absorption structure according to claim 1, wherein the shock-absorption structure further comprises a third shock-absorption body;
a movable gap is configured between the first shock-absorption body and the third shock-absorption body; and
the first shock-absorption body and the third shock-absorption body are connected via at least one elastic shock-absorbing component.
